(19) United States
(12) Patent Application Publication
(10) Pub. No.: US 2022/0347755 A1
(43) Pub. Date: Nov. 3, 2022

(54) CARRIER ARRANGEMENT FOR USE IN A PLANT FOR SELECTIVE POWDER MELTING

(71) Applicant: REALIZER GMBH, Borchen (DE)

(72) Inventors: Guido ADAM, Paderborn (DE); Meinolf Tepper, Rheda-Wiedenbrück (DE); Marc TIMMER, Paderborn (DE)

(73) Assignee: REALIZER GMBH, Borchen (DE)

(21) Appl. No.: 17/762,283

(22) PCT Filed: Sep. 9, 2020
(86) PCT No.: PCT/EP2020/075133

§ 371 Date: Mar. 21, 2022

(30) Foreign Application Priority Data
Sep. 23, 2019 (DE) 10 2019 214 489.6

(51) Int. Cl. B22F 12/30; B22F 10/28; B22F 12/17

(52) U.S. Cl. CPC B22F 12/30; B22F 10/28; B22F 12/17; B33Y 30/00

(57) ABSTRACT

A carrier arrangement for use in a plant for producing items according to a method for selective powder melting by building layers made of powdery material. The carrier arrangement includes a building panel on which the item to be produced is built. The carrier arrangement includes a base panel permanently assigned to an external component of the plant. The carrier arrangement includes a clamping system to detachably connect the building panel to the base panel and to position the building panel at a clamping position such that, in a clamped state, the building panel is arranged above the base panel. The carrier arrangement includes a heating system comprising at least one heating element for emitting heat for heating the building panel, wherein the at least one heating element is arranged above the clamping position.

The present invention relates to a carrier arrangement for use in a plant for producing items according to the method for selective powder melting by building layers made of powdery material, comprising a building panel which is provided to build the item to be produced thereon, a base panel which is permanently assigned to an external component of the plant, a clamping system which is provided to detachably connect the building panel to the base panel and to position it at a clamping position in such a way that, in a clamped state, the building panel is arranged above the base panel, and a heating system which comprises at least one heating element for emitting heat and is set up to heat the building panel.

It is known, using the method for selective powder melting with the help of a laser light source, to produce mouldings such as machine parts, tools, prostheses, pieces of jewellery, etc. according to geometry description data of the corresponding mouldings by building layers made of metallic or ceramic material powder, in which, in a production process of this type, a plurality of powder layers are applied one after the other and each powder layer is heated with a focused laser beam in a predetermined region, which region corresponds to a selected cross-sectional surface of the model of the shaped body, before the application of the next powder layer, so that the material powder is remelted in the irradiated regions to form cohesive solidified portions. Regarding the prior art in this field, reference is made, for example, to DE 199 05 067 A1, DE 101 12 591 A1, WO 98/24574 A, DE 10 2009 038 165 A1, DE 10 2012 221 641 A1, EP 2 052 845 A2, DE 10 2005 014 483 A1, and WO 2017/084781 A1.

In plants for carrying out a method of this type, the item to be produced is built on a building panel which is successively lowered by means of a lifting device during continuous operation of the system in order to compensate for the increasing height of the item being built on the building panel in such a way that the irradiation of subsequent layers can always take place at substantially the same vertical height. In the context of the present invention, the lifting device acts as the “external component of the plant” to which the base panel is permanently assigned. In this way, on the one hand, the irradiation process itself is simplified and, on the other hand, in particular the preparation of subsequent powder layers by means of a powder preparation device provided for this purpose.

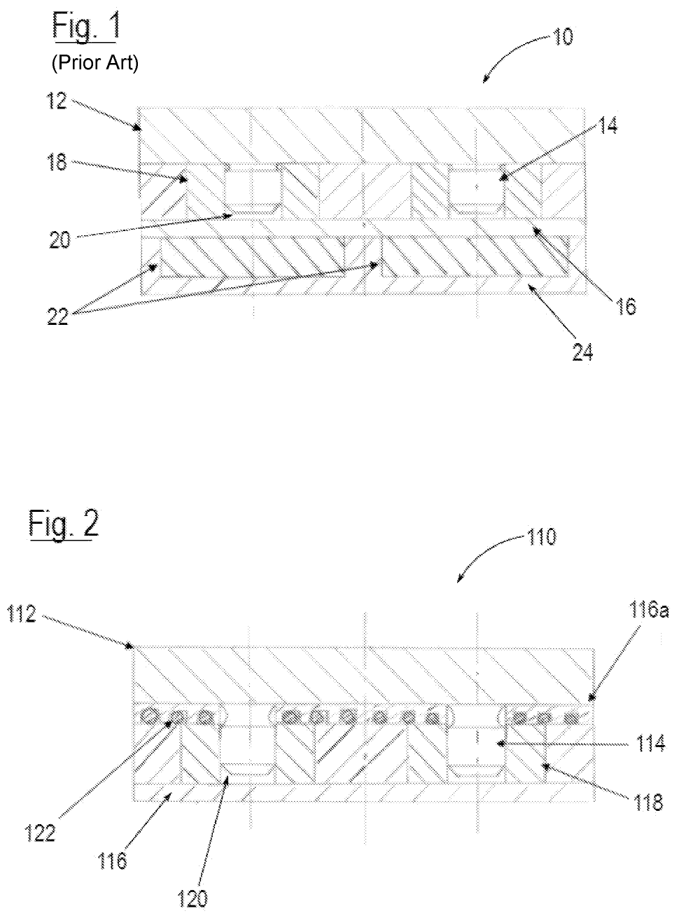

It has been shown that, in order to maintain or reduce component tolerances in the items to be produced, it is advantageous to heat the building panel by means of a heating system in order to reduce temperature differences between the melted component and the building panel. In previously known plants, the heating system having the associated heating elements thereof has been provided in the region of the base panel or a machine table arranged below it, as can be seen, for example, from FIG. 1 which schematically shows a generic carrier arrangement from the prior art.

In this case, the carrier system 10 from the prior art, viewed from top to bottom in a vertical direction, initially comprises a building panel 12 on which the item to be produced is built during operation of the plant and which is provided on its underside with clamping spigots 14 for clamping it. Said clamping spigots 14 are clamped with the aid of clamping devices 18 assigned to a base panel 16 during operation of the plant, the clamping spigots 14 extending into corresponding recesses 20 in the base panel 16. In this case, the clamping position is formed by the plane in which the actual engagement between the clamping devices 18 and the clamping spigot 14 takes place, the term “plane” of course not being understood strictly geometrically, but rather should include the fact that the engagement in the height direction of the clamping system takes place over a specific height range.

Underneath the base panel 16, heating elements 22 embedded in the machine table 24 carrying the base panel 16 are provided which, in the embodiment shown from the prior art, can be, for example, flat ceramic heating elements that radiate heat in a known manner for heating the building panel 12. After the completion of the production process of the item on the building panel 12, the clamping devices are detached, and the building panel 12, together with the item, can be removed from the base panel 16 and out of the plant for further processing thereof.

It has been shown, however, that the generic carrier arrangement 10 known from the prior art has some disadvantages during operation. On the one hand, due to the predetermined geometry of the heating elements, it is impossible to set a completely homogeneous temperature over the entire building panel, since, due to the arrangement of the heating elements, only heating zones can be implemented which do not cover the entire building field. Furthermore, when using the clamping system, the distance between the building panel itself and the heating system or the individual heating elements is relatively large, so that the heating power effectively acting on the building panel is significantly reduced. Furthermore, since the clamping system itself, as a component provided between the heating system and the building panel, is also exposed to the heating power of the heating system, in addition to an inhomogeneous heat transfer to the building panel due to the inevitable absorption of heat by the clamping system, there is also a considerable thermal load which impairs both the service life as well as the precision of the plant.

It is therefore the object of the present invention to provide an improved generic carrier arrangement for use in a plant for producing items according to the method for selective powder melting by building layers made of powdery material, which carrier arrangement is characterised, on the one hand, by improved energy efficiency and, on the other hand, by gentler heating operation for the components of the carrier arrangement. For this purpose and to achieve this object, the at least one heating element is arranged above the clamping position in the carrier arrangement according to the invention.

It goes without saying that the terms “top” and “bottom” are to be understood in such a way that the item to be produced with the plant is built from bottom to top and thus the building panel which ultimately carries the item to be produced is the topmost component of the carrier arrangement, while the base panel must always be arranged underneath it. Accordingly, the clamping position also relates in particular to the height direction and consequently describes the height position of the corresponding engagement.

Thus, according to the invention, by arranging the at least one heating element above the clamping position, the distance between the component to be heated, namely the building panel, and the at least one heating element is significantly reduced, so that, on the one hand, more efficient heating can take place and, on the other hand, the number and mass of the components of the carrier arrangement present between the heating elements and the building panel is reduced, which components consequently do not have to be heated therewith and are therefore exposed to a reduced thermal load.

This applies in particular to the clamping system of the carrier arrangement, which clamping system in an embodiment according to the invention can include clamping spigots that are assigned to the building panel, as well as recesses in the base panel, in which recesses, when the building panel is in the clamped state, the clamping spigots are clamped by means of corresponding clamping devices which are also part of the clamping system, the clamping position being formed by a clamping plane. In this case, again, the term “plane” is not to be understood strictly geometrically.

In this case, the at least one heating element can be arranged in particular in the region of the upper side of the base panel and also have openings through which the clamping spigots extend when the building panel is in the clamped state. In this way, it is achieved that, in the clamped state mentioned, the clamping spigots lie completely or at least to a large extent underneath the at least one heating element and are consequently heated to a significantly lesser extent by the heating power of the at least one heating element. As a result, in an embodiment of this type, the thermal loads on the clamping system are reduced and the efficiency of the heating system is increased compared to the prior art discussed above.

The mentioned advantageous effect can be maximised in that, in the clamped state, the at least one heating element is arranged completely above the clamping devices of the clamping system assigned to the base panel.

In an alternative embodiment, however, the at least one heating element could also be integrated into the building panel, an energy interface also having to be provided, by means of which the at least one heating element can be connected to an energy source in the clamped state of the building panel, which energy source is also a part of the heating system. In particular, the building panel can be built from two superimposed regions which can be connected to and detached from one another, the at least one heating element being integrated into the lower region. Thus, only the upper region of the building panel that can be detached from the lower region serves directly as a carrier for the item to be produced and can be dismantled from the lower region and replaced after completion of the production process. In this case, the detachable connection of the two regions can be established by any suitable means, for example by a screw connection.

In both of the above-mentioned embodiments, the at least one heating element can be formed by a heating wire which is preferably laid in a loop or meander shape in one plane. In this case, both a flexible heating wire can be provided, which is adapted in a suitable shape to the component carrying it during its assembly, or a heating wire preformed according to a predetermined shape, to which shape the corresponding component then only has to be assigned in a finished shape. In the usual known manner, a heating element formed by a heating wire can be operated by an electrical current which is converted into heat in accordance with the ohmic resistance of the wire.

In order to further increase the efficiency of the heating system of the carrier arrangement according to the invention and furthermore to be able to achieve further improved protection of components of the carrier arrangement from undesired thermal loading, the at least one heating element can be surrounded at least in sections by a heat insulation element on at least one side. In this way, the emission of heat is concentrated in the intended direction towards the building panel to be heated. In this case, known thermal insulation elements can be provided, such as ceramic tiles or other materials with the lowest possible thermal conductivity.

According to a further aspect, the present invention relates to a plant for producing items according to the method for selective powder melting by building layers made of powdery material, comprising an installation space which is set up to receive the item to be produced, a powder delivery device which is set up to feed material powder into the installation space, a powder layer preparation unit which is set up to prepare successive layers of the fed material powder, an irradiation device which is set up to irradiate a powder layer that was prepared last and thus melt it locally, and a carrier arrangement according to the invention, which carrier arrangement is arranged in a height-adjustable manner in the installation space.

Further features and advantages of the present invention will become even clearer from the following description of an embodiment when said embodiment is considered together with the accompanying drawings. In detail, in the drawings:

FIG. 1 shows a generic carrier arrangement from the prior art in a schematic side sectional view;

FIG. 2 shows an embodiment of a carrier arrangement according to the invention in a schematic side sectional view;

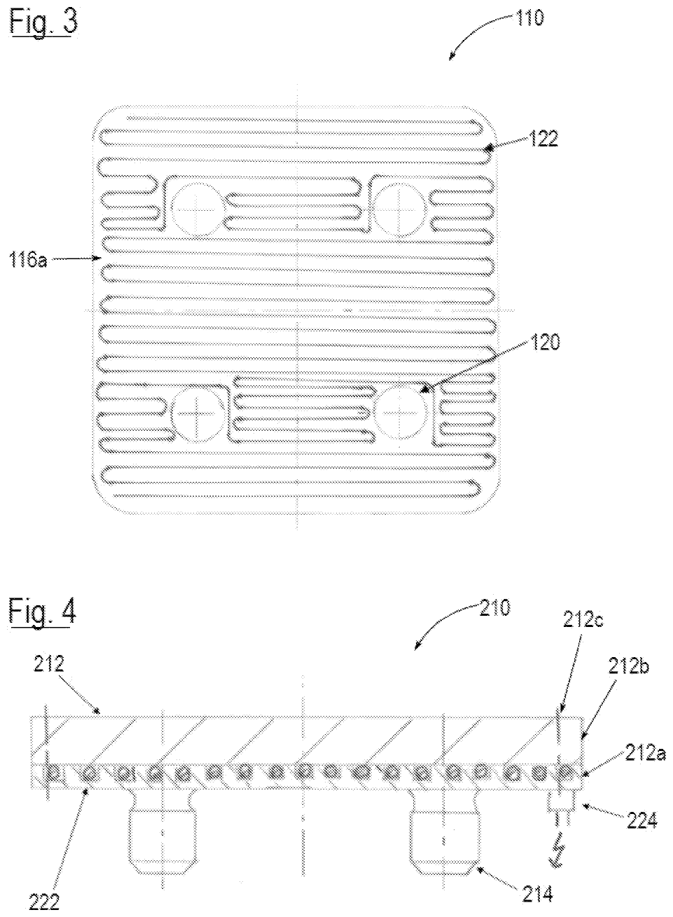

FIG. 3 shows the embodiment of FIG. 2 in a schematic plan view;

FIG. 4 is a partial view of a second embodiment of a carrier arrangement according to the invention in a schematic side sectional view; and

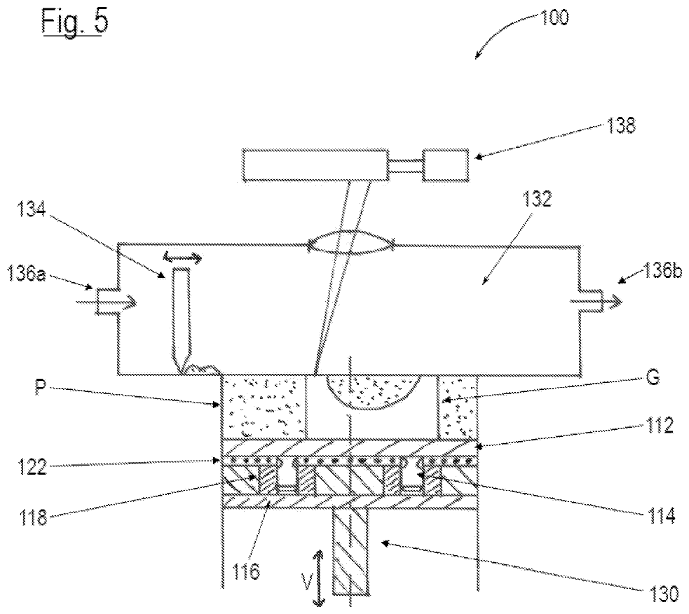

FIG. 5 shows a plant according to the invention for selective powder melting, comprising the embodiment from FIG. 2, in a schematic side sectional view.

With reference to FIG. 1 already described above, which shows a generic carrier arrangement for use in a plant for producing items according to the method for selective powder melting from the prior art, the carrier arrangement according to the invention shown in FIG. 2 in a similar view will now be described.

This carrier arrangement is designated quite generally with the reference sign 110 and also comprises a building panel 112 which, during operation in a plant provided with the carrier arrangement shown, is provided to build the item to be produced thereon.

Building panels of this type usually consist of a suitable metal which allows the lowermost layer of selectively melted powder to adhere thereto and ensures good dissipation of the heat generated when the powder melts. After completion of the production process, the item produced in this way is then finally separated from the building panel, so that it can be used again, if necessary, after a suitable preparation.

On its underside, the building panel 112 has clamping spigots 114 in a manner similar to the carrier arrangement from the prior art described in FIG. 1, which clamping spigots lie in recesses 120 of a base panel 116 and are clamped there by corresponding clamping devices 118, the clamping spigot 114 and the clamping device 118 together forming the clamping system within the meaning of the present application, and the clamping position is formed by the region in which the clamping devices 118 and the clamping spigots 114 are actually in contact. In the embodiment shown, this clamping position is formed by a plane in the broad sense of the present application.

In the uppermost region 116a of the base panel 116, i.e. in the surface perforated by the recesses 120 directly underneath the building panel 112, a heating wire 122 is embedded, which heating wire forms the heating element in the embodiment of a carrier arrangement 110 according to the invention shown in FIG. 2. As can also be seen from the schematic top view shown in FIG. 3, the heating wire 122 is guided in a meandering manner over the entire upper side of the base panel 116, it being only guided around the recesses 120 in a suitable manner with the formation of corresponding openings.

Despite these provided recesses 120, the surface coverage that can be achieved with the heating wire 122 or the proportion of the entire top view surface of the base panel 116 that is covered with the heating wire 122 is significantly larger than the surface that can be achieved with the carrier arrangement 10 from the prior art shown with the heating elements 22 in FIG. 1. Furthermore, the heating wire 122 is positioned much closer to the base panel 112 to be heated, compared to the heating elements 22 from FIG. 1, so that, on the one hand, significantly reduced heat losses occur when the heat is transported from the heating element 122 to the building panel 112 to be heated and thus the efficiency of the heating device 122 is improved, and, on the other hand, significantly less heat is emitted into further components of the carrier arrangement 110, for example into the clamping spigots 114 and the clamping devices 118, so that these components are exposed to a significantly reduced thermal load.

While the heating wire 122 in FIGS. 2 and 3 can be fed from below without any problems through suitably laid electrical lines from the region of the base panel 116 and the machine table thereof (not shown), an energy interface 224 can be provided in the second embodiment 210 of a carrier arrangement according to the invention (only partially shown in FIG. 4), which energy interface must establish a plug-in connection to a counter element (not shown) in the clamped state of the exchangeable building panel 212 (also shown in FIG. 4), so that energy can be fed to the heating wire 222.

In the embodiment shown in FIG. 4, the heating wire 222 is integrated directly into the building panel 212 in the lower region 212a thereof, so that the heating wire 222 can be guided over the entire horizontal surface of the building panel 212 in a manner that is completely free of obstructions. In particular, there is no influence in this case from the clamping spigots 214 arranged completely underneath the heating wire 222. In an operating state of the carrier arrangement 210, the mentioned clamping spigots 214 are again clamped in a base panel (not shown in FIG. 4), which base panel differs from the base panels described so far only in that it does not itself comprise any heating elements.

The only disadvantage of the embodiment shown in FIG. 4, besides the necessary provision of the energy interface 224, is that the heating wire 222 is now provided in the building panel 212 itself, which, as mentioned above, must be separated therefrom in a process step after building the item to be produced. For this purpose, the building panel 212 itself is again built in two parts and comprises, in addition to the lower region 212a, an upper region 212b, the two regions 212a and 212b being detachably connected to one another by suitable means, for example by a screw connection 212c indicated in FIG. 4. Thus, the upper region 212b can serve as a sacrificial component that can be replaced after the end of the production process of the corresponding item.

In a variant of the embodiment from FIG. 4, a base panel equipped with a heating element could also serve as a sacrificial component and thus be made in one piece, but this would result in increased costs in the operation of the plant, since the base panel which is equipped with the heating element and which is therefore significantly more expensive would have to be replaced after a single use.

Finally, FIG. 5 shows a system according to the invention for producing items according to the method for selective powder melting by building the powdery material in layers, which plant is generally designated by the reference sign 100, and which is used in the embodiment of a carrier arrangement 110 according to the invention from FIG. 2.

With reference to this FIG. 2, a new description of the carrier arrangement 110 is dispensed with; it should only be pointed out that the already mentioned displacement of the carrier arrangement 110 in the vertical direction, as indicated by the arrow V in FIG. 5, takes place by a corresponding machine table 130, which is only shown very schematically in FIG. 5.

Furthermore, the plant 100 comprises an installation space 132 in which the item G to be produced, which item is built on the building panel 112, is provided. This item G is built in layers made of a powder P by selective melting and solidification thereof, new powder being fed into the installation space 132 by a powder delivery unit (not shown) after the melting and solidification of each layer of the powder P to form a layer of the item G and is prepared there in a suitable manner by a powder layer preparation unit 134.

In order to prevent oxidation of the powder P during the production of the item G, a protective gas system is also provided, which is indicated in FIG. 5 only by a protective gas inlet 136a and a protective gas outlet 136b. Finally, the plant 100 comprises an irradiation device 138 which comprises a laser and optical components and is controlled by a control device (not shown) in such a way that the focused laser beam of the irradiation device 138 scans the prepared powder P when producing each layer of the item G in such a way that the corresponding layer of the item G is formed in the desired manner.

Not shown in FIG. 5, but optionally to be used in a plant of this type, an infrared heater can also be provided which heats the powder P from above and, to a certain extent, heats the building panel 112 from above at the start of the production process.

1. A carrier arrangement for use in a plant for producing items according to a method for selective powder melting by building layers made of powdery material, the carrier arrangement comprising:
a building panel on which the item (G) to be produced is built;
a base panel permanently assigned to an external component of the plant;
a clamping system to detachably connect the building panel to the base panel and to position the building panel at a clamping position such that, in a clamped state, the building panel is arranged above the base panel; and
a heating system comprising at least one heating element for emitting heat for heating the building panel,
wherein the at least one heating element is arranged above the clamping position.

2. The carrier arrangement of claim 1, wherein the clamping comprises clamping spigots assigned to the building panel and recesses in the base panel, wherein when the building panel is in the clamped state, the clamping spigots are clamped in the recesses by means of corresponding clamping devices, the clamping position being formed by a clamping plane.

3. The carrier arrangement of claim 2, wherein the at least one heating element is arranged in a region of an upper side of the base panel and comprises openings through which the clamping spigots extend when the building panel is in the clamped state.

4. The carrier arrangement of claim 3, wherein, in the clamped state, the at least one heating element is arranged completely above the clamping devices.

5. The carrier arrangement of claim 1, wherein the at least one heating element is integrated into the building panel and wherein the carrier arrangement further comprises an energy interface by means of which the at least one heating element is connectable to an energy source in the clamped state of the building panel.

6. The carrier arrangement of claim 5, wherein the building panel comprises two superimposed regions that can be connected to and detached from one another, the at least one heating element being integrated into the lower region.

7. The carrier arrangement of claim 1, wherein the at least one heating element is formed by a heating wire.

8. The carrier arrangement of claim 1, wherein the at least one heating element is at least partially surrounded on at least one side by a heat insulation element.

9. A plant for producing items according to a method for selective powder melting by building layers made of powdery material, the plant comprising:
an installation space to receive the item to be produced;
a powder delivery device to feed material powder into the installation space;
a powder layer preparation unit to prepare successive layers of the fed material powder;
an irradiation device to irradiate a powder layer that was prepared last and to melt the powder layer locally; and
a carrier arrangement arranged in a height-adjustable manner in the installation space, the carrier arrangement comprising:
a building panel on which the item to be produced is built;
a base panel permanently assigned to an external component of the plant;
a clamping system to detachably connect the building panel to the base panel and to position the building panel at a clamping position such that, in a clamped state, the building panel is arranged above the base panel; and
a heating system comprising at least one heating element for emitting heat for heating the building panel, wherein the at least one heating element is arranged above the clamping position.

10. The plant of claim 9, wherein the clamping system of the carrier arrangement comprises clamping spigots assigned to the building panel and recesses in the base panel, wherein when the building panel is in the clamped state, the clamping spigots are clamped in the recesses by means of corresponding clamping devices, the clamping position being formed by a clamping plane.

11. The plant of claim 10, wherein the at least one heating element of the carrier arrangement is arranged in a region of an upper side of the base panel and comprises openings through which the clamping spigots extend when the building panel is in the clamped state.

12. The plant of claim 11, wherein, in the clamped state, the at least one heating element of the carrier arrangement is arranged completely above the clamping devices.

13. The plant of claim 9, wherein the at least one heating element of the carrier arrangement is integrated into the building panel and wherein the carrier arrangement further comprises an energy interface by means of which the at least one heating element is connectable to an energy source in the clamped state of the building panel.

14. The plant of claim 13, wherein the building panel of the carrier arrangement comprises two superimposed regions that can be connected to and detached from one another, the at least one heating element being integrated into the lower region.

15. The plant of claim 9, wherein the at least one heating element of the carrier arrangement is formed by a heating wire.

16. The plant of claim 9, wherein the at least one heating element of the carrier arrangement is at least partially surrounded on at least one side by a heat insulation element.

17. The plant of claim 15, wherein the heating element of the carrier arrangement is laid in a loop or meander shape in one plane.

18. The carrier arrangement of claim 7, wherein the heating element is laid in a loop or meander shape in one plane.
